(19) United States
(12) Patent Application Publication
(10) Pub. No.: US 2023/0156742 A1
(43) Pub. Date: May 18, 2023

(54) MULTIPLE TCI STATE ACTIVATION FOR PDCCH AND PDSCH

(71) Applicant: QUALCOMM Incorporated, San Diego, CA (US)

(72) Inventors: Ruiming ZHENG, Beijing (CN); Yu ZHANG, San Diego, CA (US); Muhammad Sayed Khairy ABDELGHAFFAR, San Jose, CA (US); Runxin WANG, San Diego, CA (US); Linhai HE, San Diego, CA (US); Alexandros MANOLAKOS, Escondido, CA (US); Krishna Kiran MUKKAVILLI, San Diego, CA (US); Hwan Joon KWON, San Diego, CA (US)

(21) Appl. No.: 17/917,517

(22) PCT Filed: Apr. 30, 2020
(86) PCT No.: PCT/CN2020/088439

§ 371 Date: Oct. 6, 2022

(51) Int. Cl. H04W 72/232; H04W 72/231; H04L 5/00; H04W 72/12

(52) U.S. Cl. CPC H04W 72/232; H04W 72/231; H04L 5/0051; H04L 5/0094; H04W 72/12

(57) ABSTRACT

Aspects of the present disclosure relate to wireless communications, and more particularly, to techniques for activating multiple TCI states for PDSCH and/or PDCCH transmissions.

### TECHNICAL FIELD

Aspects of the present disclosure relate to wireless communications, and more particularly, to techniques for activating multiple transmission configuration indicator (TCI) states, for example, for physical downlink control channel (PDCCH) and physical downlink shared channel (PDSCH) transmissions.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., which may be referred to as a base station, 5G NB, next generation NodeB (gNB or gNodeB), TRP, etc.). A base station or distributed unit may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. New Radio (NR) (e.g., 5G) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide a method for wireless communications by a user equipment (UE). The method generally includes receiving signaling indicating candidate transmission configuration indicator (TCI) states, receiving a downlink control information (DCI) scheduling a physical downlink shared channel (PDSCH) with a TCI code point that indicates more than 2 TCI states for receiving the PDSCH, and processing the scheduled PDSCH in accordance with the TCI states indicated by the TCI code point.

Certain aspects of the present disclosure provide a method for wireless communications by a network entity. The method generally includes transmitting signaling to a user equipment (UE) indicating candidate transmission configuration indicator (TCI) states, transmitting a downlink control information (DCI) scheduling a physical downlink shared channel (PDSCH) with a TCI code point that indicates more than 2 TCI states for receiving the PDSCH, and transmitting the scheduled PDSCH in accordance with the TCI states indicated by the TCI code point.

Certain aspects of the present disclosure provide a method for wireless communications by a user equipment (UE). The method generally includes receiving signaling indicating candidate transmission configuration indicator (TCI) states, receiving a medium access control (MAC) control element (CE) that supports indicating more than one of the TCI states is activated for processing a physical downlink control channel (PDCCH), and monitoring for a PDCCH transmission in accordance with TCI states indicated as activated in the MAC CE.

Certain aspects of the present disclosure provide a method for wireless communications by a network entity. The method generally includes transmitting a user equipment (UE) signaling indicating candidate transmission configuration indicator (TCI) states, transmitting a medium access control (MAC) control element (CE) that supports indicating more than one of the TCI states is activated for processing a physical downlink control channel (PDCCH), and transmitting a PDCCH transmission in accordance with TCI states indicated as activated in the MAC CE.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIG. 3 illustrates an example of a frame format for a new radio (NR) system, in accordance with certain aspects of the present disclosure.

FIG. 4 illustrates how different synchronization signal blocks (SSBs) may be sent using different beams, in accordance with certain aspects of the present disclosure.

FIG. 5 shows an exemplary transmission resource mapping, according to aspects of the present disclosure.

FIG. 6 illustrates example quasi co-location (QCL) relationships, in accordance with certain aspects of the present disclosure.

FIGS. 7A-7B are diagrams illustrating example multiple transmission reception point (TRP) transmission scenarios, in accordance with certain aspects of the present disclosure.

FIG. 8 illustrates an example single frequency network (SFN) multiple transmission reception point (TRP) scenario, in accordance with certain aspects of the present disclosure.

FIG. 9 illustrates an example mechanism for activating transmission configuration indicator (TCI) states.

FIGS. 10A and 10B illustrate example mechanisms for activating multiple transmission configuration indicator (TCI) states.

FIG. 11 illustrates example operations for wireless communications by a user equipment (UE), in accordance with certain aspects of the present disclosure.

FIG. 12 illustrates example operations for wireless communications by a network entity, in accordance with certain aspects of the present disclosure.

FIG. 13 illustrates an example mechanism for activating multiple transmission configuration indicator (TCI) states, in accordance with certain aspects of the present disclosure.

FIGS. 14A-14B illustrate example mechanisms for activating multiple transmission configuration indicator (TCI) states, in accordance with certain aspects of the present disclosure.

FIGS. 15A-15B illustrate example mechanisms for activating multiple transmission configuration indicator (TCI) states, in accordance with certain aspects of the present disclosure.

FIG. 16 illustrates example operations for wireless communications by a user equipment (UE), in accordance with certain aspects of the present disclosure.

FIG. 17 illustrates example operations for wireless communications by a network entity, in accordance with certain aspects of the present disclosure.

FIGS. 18A-18B illustrate example mechanisms for activating multiple transmission configuration indicator (TCI) states, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, devices, methods, processing systems, and computer readable mediums for activating multiple transmission configuration indicator (TCI) states, for example, for physical downlink control channel (PDCCH) and physical downlink shared channel (PDSCH) transmissions.

As will be described in greater detail below, in some cases, the multiple TCI states may correspond to different transmitter reception points (TRPs). For example, in a single frequency network (SFN) multi-TRP scenario, different TRPs may transmit the same PDSCH and/or PDCCH, with different QCL assumptions indicated by the activated TCI states.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

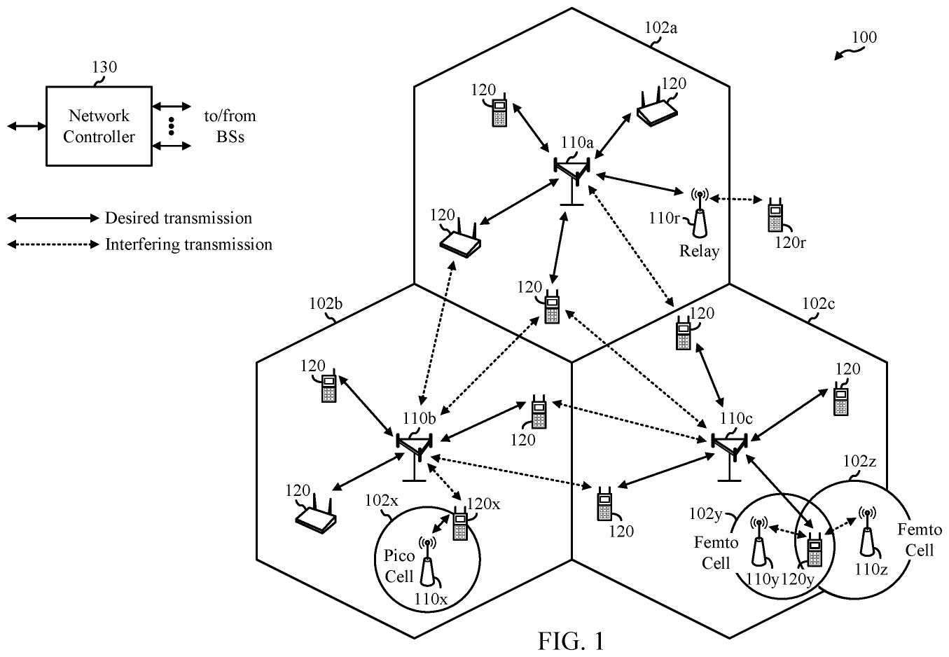

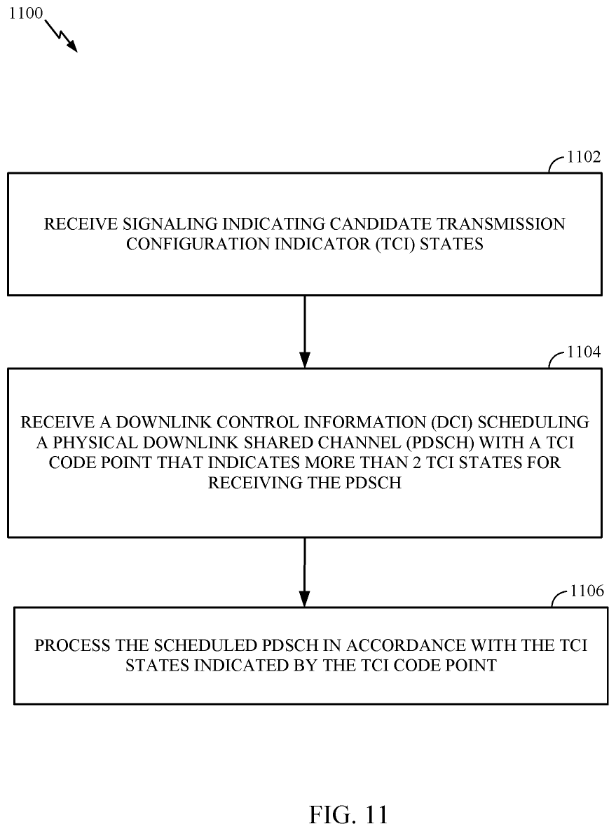

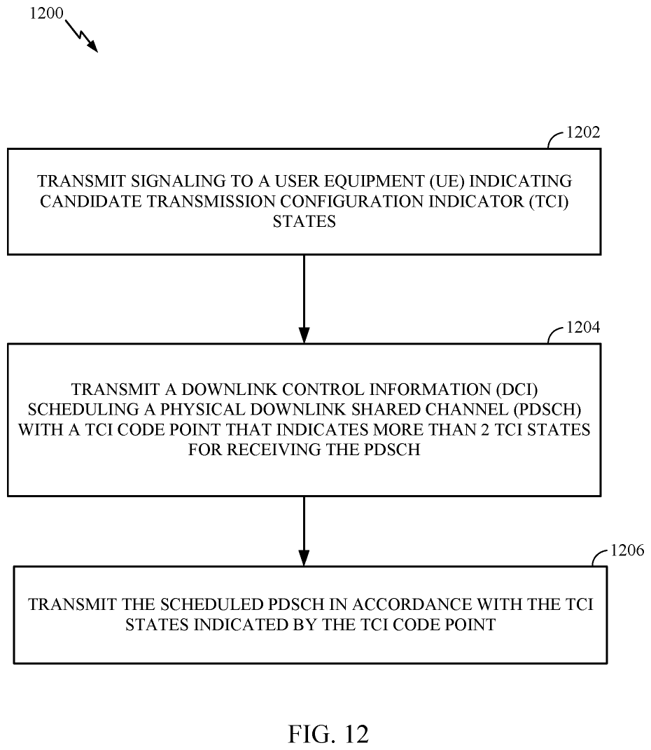

FIG. 1 illustrates an example wireless communication network 100 (e.g., an NR/5G network), in which aspects of the present disclosure may be performed. For example, the wireless network 100 may include a UE 120 configured to perform operations 1100 of FIG. 11 to determine quasi co-location (QCL) assumptions for PDCCH and/or PDSCH transmissions from multiple transmitter receiver points (TRPs). Similarly, the wireless network 100 may include a base station 110 configured to perform operations 1200 of FIG. 12 to activate multiple TCI states corresponding to QCL assumptions for PDCCH and/or PDSCH transmissions.

As illustrated in FIG. 1, the wireless network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a NodeB (NB) and/or a NodeB subsystem serving this coverage area, depending on the context in which the term is used. In NR systems, the term “cell” and next generation NodeB (gNB), new radio base station (NR BS), 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area to avoid interference between wireless networks of different RATs. In some cases, NR or 5G RAT networks may be deployed.

A base station (BS) may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. ABS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r to facilitate communication between the BS 110a and the UE 120r. A relay station may also be referred to as a relay BS, a relay, etc.

Wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, gaming device, reality augmentation device (augmented reality (AR), extended reality (XR), or virtual reality (VR)), or any other suitable device that is configured to communicate via a wireless or wired medium.

Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some scenarios, air interface access may be scheduled. For example, a scheduling entity (e.g., a base station (BS), Node B, eNB, gNB, or the like) can allocate resources for communication among some or all devices and equipment within its service area or cell. The scheduling entity may be responsible for scheduling, assigning, reconfiguring, and releasing resources for one or more subordinate entities. That is, for scheduled communication, subordinate entities can utilize resources allocated by one or more scheduling entities.

Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

Turning back to FIG. 1, this figure illustrates a variety of potential deployments for various deployment scenarios. For example, in FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS. Other lines show component to component (e.g., UE to UE) communication options.

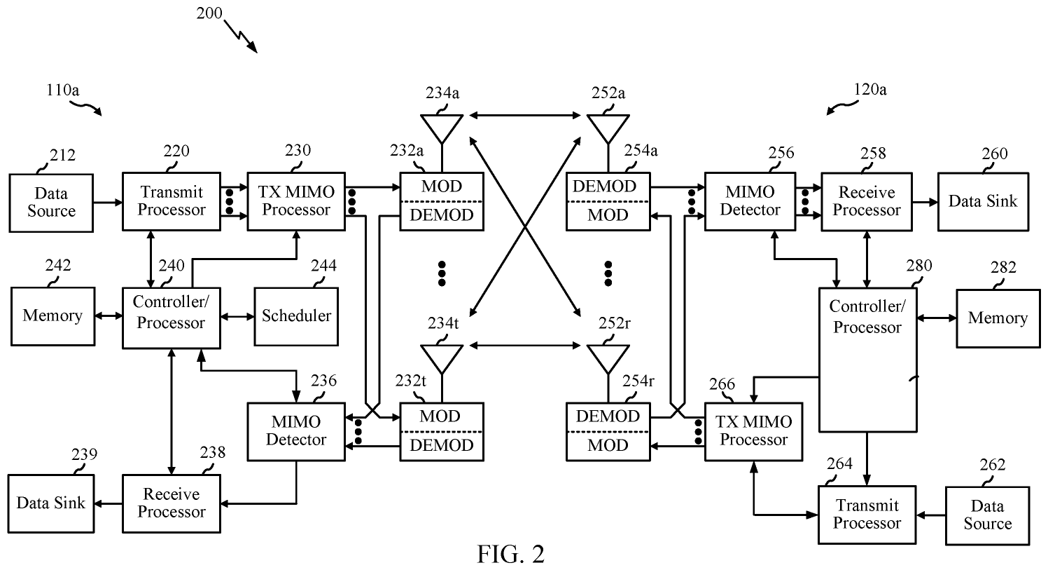

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

The controller/processor 280 and/or other processors and modules at the UE 120a may perform or direct the execution of processes for the techniques described herein. For example, controller/processor 280 and/or other processors and modules at the UE 120a may perform (or be used by UE 120a to perform) operations 1100 of FIG. 11. Similarly, the controller/processor 240 and/or other processors and modules at the BS 110a may perform or direct the execution of processes for the techniques described herein. For example, controller/processor 240 and/or other processors and modules at the BS 110a may perform (or be used by BS 121a to perform) operations 1200 of FIG. 12. Although shown at the controller/processor, other components of the UE 120a or BS 110a may be used to perform the operations described herein.

Embodiments discussed herein may include a variety of spacing and timing deployments. For example, in LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

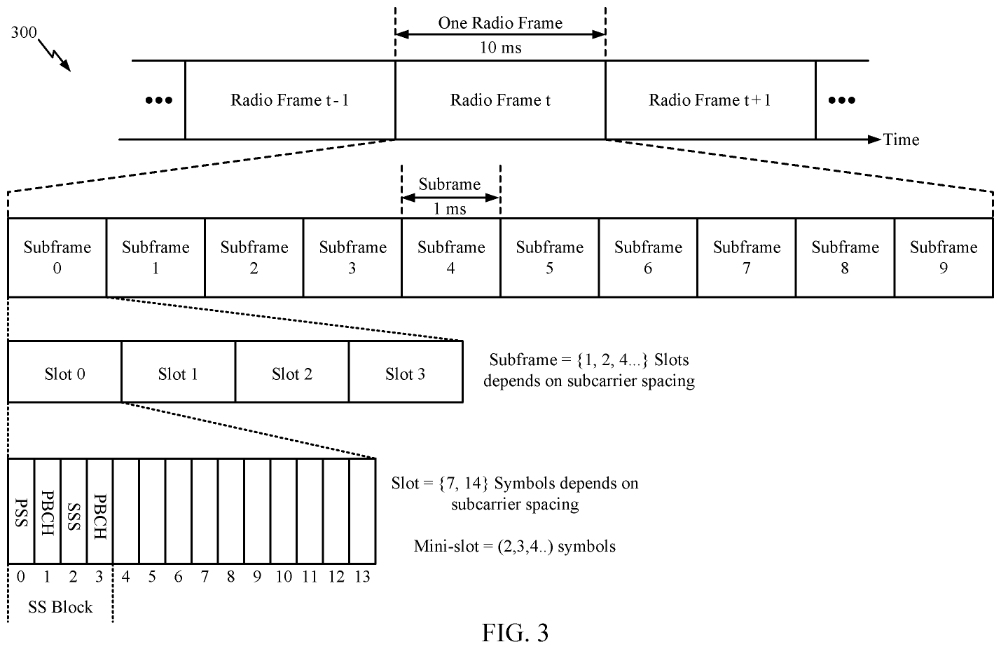

FIG. 3 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot is a subslot structure (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

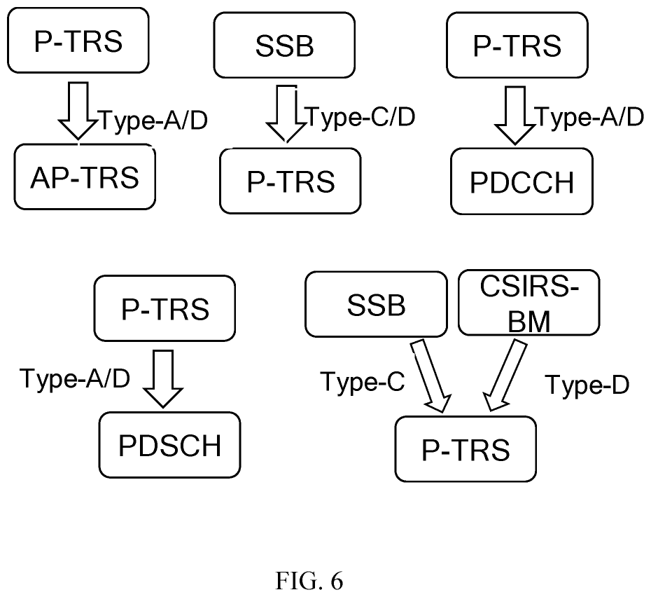

In NR, a synchronization signal (SS) block (SSB) is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing, and the SS may provide the CP length and frame timing. The PSS and SSS may provide the cell identity. The PBCH carries some basic system information, such as downlink system bandwidth, timing information within radio frame, SS burst set periodicity, system frame number, etc.

Further system information such as, remaining minimum system information (RMSI), system information blocks (SIBs), other system information (OSI) can be transmitted on a physical downlink shared channel (PDSCH) in certain subframes.

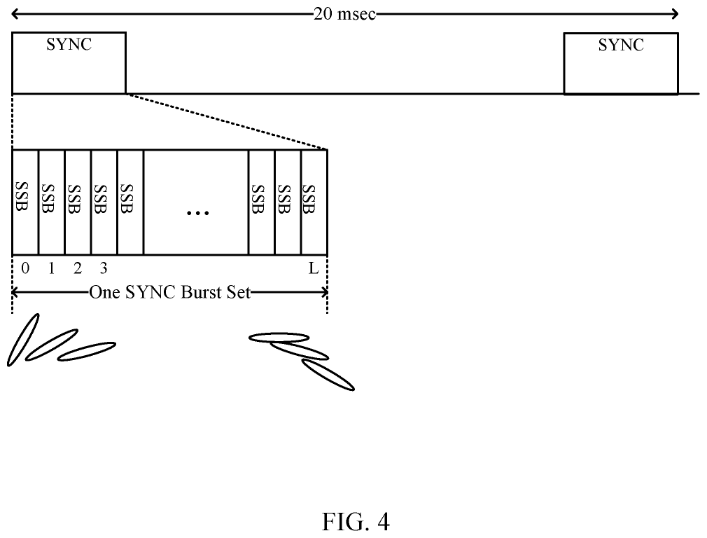

As shown in FIG. 4, the SS blocks may be organized into SS burst sets to support beam sweeping. As shown, each SSB within a burst set may be transmitted using a different beam, which may help a UE quickly acquire both transmit (Tx) and receive (Rx) beams (particular for mmW applications). A physical cell identity (PCI) may still decoded from the PSS and SSS of the SSB.

Certain deployment scenarios may include one or both NR deployment options. Some may be configured for non-standalone (NSA) and/or standalone (SA) option. A standalone cell may need to broadcast both SSB and remaining minimum system information (RMSI), for example, with SIB1 and SIB2. A non-standalone cell may only need to broadcast SSB, without broadcasting RMSI. In a single carrier in NR, multiple SSBs may be sent in different frequencies, and may include the different types of SSB.

### Control Resource Sets (CORESETs)

A control resource set (CORESET) for an OFDMA system (e.g., a communications system transmitting PDCCH using OFDMA waveforms) may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE. Search spaces are generally areas or portions where a communication device (e.g., a UE) may look for control information.

According to aspects of the present disclosure, a CORESET is a set of time and frequency domain resources, defined in units of resource element groups (REGs). Each REG may comprise a fixed number (e.g., twelve) tones in one symbol period (e.g., a symbol period of a slot), where one tone in one symbol period is referred to as a resource element (RE). A fixed number of REGs may be included in a control channel element (CCE). Sets of CCEs may be used to transmit new radio PDCCHs (NR-PDCCHs), with different numbers of CCEs in the sets used to transmit NR-PDCCHs using differing aggregation levels. Multiple sets of CCEs may be defined as search spaces for UEs, and thus a NodeB or other base station may transmit an NR-PDCCH to a UE by transmitting the NR-PDCCH in a set of CCEs that is defined as a decoding candidate within a search space for the UE, and the UE may receive the NR-PDCCH by searching in search spaces for the UE and decoding the NR-PDCCH transmitted by the NodeB.

Operating characteristics of a NodeB or other base station in an NR communications system may be dependent on a frequency range (FR) in which the system operates. A frequency range may comprise one or more operating bands (e.g., “n1” band, “n2” band, “n7” band, and “n41” band), and a communications system (e.g., one or more NodeBs and UEs) may operate in one or more operating bands. Frequency ranges and operating bands are described in more detail in “Base Station (BS) radio transmission and reception” TS38.104 (Release 15), which is available from the 3GPP website.

As described above, a CORESET is a set of time and frequency domain resources. The CORESET can be configured for conveying PDCCH within system bandwidth. A UE may determine a CORESET and monitors the CORESET for control channels. During initial access, a UE may identify an initial CORESET (CORESET #0) configuration from a field (e.g., pdcchConfigSIB1) in a maser information block (MIB). This initial CORESET may then be used to configure the UE (e.g., with other CORESETs and/or bandwidth parts via dedicated (UE-specific) signaling. When the UE detects a control channel in the CORESET, the UE attempts to decode the control channel and communicates with the transmitting BS (e.g., the transmitting cell) according to the control data provided in the control channel (e.g., transmitted via the CORESET).

According to aspects of the present disclosure, when a UE is connected to a cell (or BS), the UE may receive a master information block (MIB). The MIB can be in a synchronization signal and physical broadcast channel (SS/PBCH) block (e.g., in the PBCH of the SS/PBCH block) on a synchronization raster (sync raster). In some scenarios, the sync raster may correspond to an SSB. From the frequency of the sync raster, the UE may determine an operating band of the cell. Based on a cell's operation band, the UE may determine a minimum channel bandwidth and a subcarrier spacing (SCS) of the channel. The UE may then determine an index from the MIB (e.g., four bits in the MIB, conveying an index in a range 0-15).

Given this index, the UE may look up or locate a CORESET configuration (this initial CORESET configured via the MIB is generally referred to as CORESET #0). This may be accomplished from one or more tables of CORESET configurations. These configurations (including single table scenarios) may include various subsets of indices indicating valid CORESET configurations for various combinations of minimum channel bandwidth and SCS. In some arrangements, each combination of minimum channel bandwidth and SCS may be mapped to a subset of indices in the table.

Alternatively or additionally, the UE may select a search space CORESET configuration table from several tables of CORESET configurations. These configurations can be based on a minimum channel bandwidth and SCS. The UE may then look up a CORESET configuration (e.g., a Type0-PDCCH search space CORESET configuration) from the selected table, based on the index. After determining the CORESET configuration (e.g., from the single table or the selected table), the UE may then determine the CORESET to be monitored (as mentioned above) based on the location (in time and frequency) of the SS/PBCH block and the CORESET configuration.

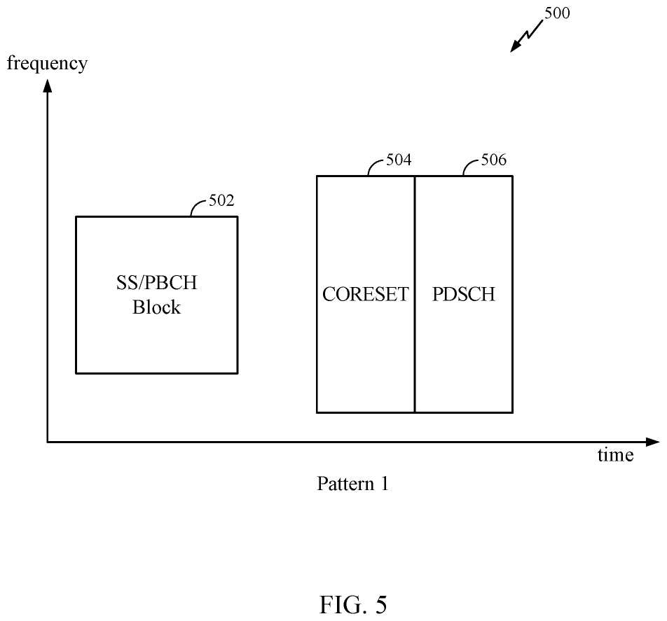

FIG. 5 shows an exemplary transmission resource mapping 500, according to aspects of the present disclosure. In the exemplary mapping, a BS (e.g., BS 110a, shown in FIG. 1) transmits an SS/PBCH block 502. The SS/PBCH block includes a MIB conveying an index to a table that relates the time and frequency resources of the CORESET 504 to the time and frequency resources of the SS/PBCH block.

The BS may also transmit control signaling. In some scenarios, the BS may also transmit a PDCCH to a UE (e.g., UE 120, shown in FIG. 1) in the (time/frequency resources of the) CORESET. The PDCCH may schedule a PDSCH 506. The BS then transmits the PDSCH to the UE. The UE may receive the MIB in the SS/PBCH block, determine the index, look up a CORESET configuration based on the index, and determine the CORESET from the CORESET configuration and the SS/PBCH block. The UE may then monitor the CORESET, decode the PDCCH in the CORESET, and receive the PDSCH that was allocated by the PDCCH.

Different CORESET configurations may have different parameters that define a corresponding CORESET. For example, each configuration may indicate a number of resource blocks (e.g., 24, 48, or 96), a number of symbols (e.g., 1-3), as well as an offset (e.g., 0-38 RBs) that indicates a location in frequency.

### CL Port and TCI States

In many cases, it is important for a UE to know which assumptions it can make on a channel corresponding to different transmissions. For example, the UE may need to know which reference signals it can use to estimate the channel in order to decode a transmitted signal (e.g., PDCCH or PDSCH). It may also be important for the UE to be able to report relevant channel state information (CSI) to the BS (gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL'd”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signalling, while a UE may be signalled to decode PDSCH according to a detected PDCCH with DCI indicating one of the TCI states. Each configured TCI state may include one RS set TCI-RS-SetConfig that indicates different QCL assumptions between certain source and target signals.

FIG. 6 illustrate examples of the association of DL reference signals with corresponding QCL types that may be indicated by a TCI-RS-SetConfig.

In the examples of FIG. 6, a source reference signal (RS) is indicated in the top block and is associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be PDSCH's DMRS, rather it can be any other RS: PUSCH DMRS, CSIRS, TRS, and SRS.

As illustrated, each TCI-RS-SetConfig contains parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter [symbol] CL-Type.

As illustrated in FIG. 6, for the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter [symbol] CL-Type and may take one or a combination of the following types:
QCL-TypeA: {Doppler shift, Doppler spread, average delay, delay spread},
QCL-TypeB: {Doppler shift, Doppler spread},
QCL-TypeC: {average delay, Doppler shift}, and
QCL-TypeD: {Spatial Rx parameter},
   Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., number of RBs) assigned to the CORESET, contiguous time duration of the CORESET in a number of symbols, and Transmission Configuration Indicator (TCI) states.

As noted above, a subset of the TCI states provide quasi co-location (QCL) relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

Search space information may also be provided via RRC signaling. For example, the SearchSpace IE is another RRC IE that defines how and where to search for PDCCH candidates for a given CORESET. Each search space is associated with one CORESET. The SearchSpace IE identifies a search space configured for a CORESET by a search space ID. In an aspect, the search space ID associated with CORESET #0 is SearchSpace ID #0. The search space is generally configured via PBCH (MIB).

### Example Multi-TRP Scenarios

In certain systems (e.g., NR Release 16), multi-TRP operation may be introduced to increase system capacity as well as reliability. Various modes of operation are supported for multi-TRP operation.

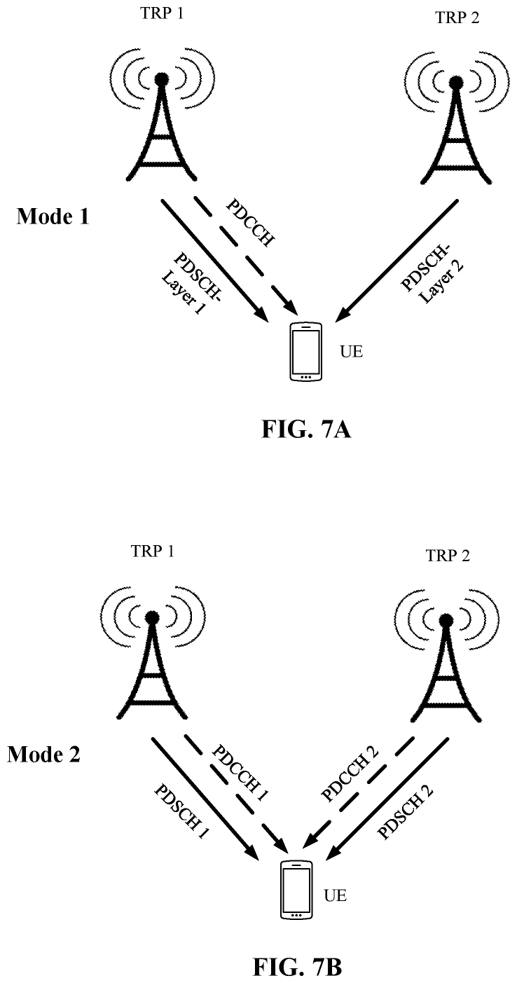

In a first mode (Mode 1), a single PDCCH schedules single PDSCH from multiple TRPs, as illustrated in FIG. 7A. In this mode, different TRPs transmit different spatial layers in overlapping RBs/symbols (spatial division multiplexing-SDM). The different TRPs transmit in different RBs (frequency division multiplexing-FDM) and may transmit in different OFDM symbols (time division multiplexing-TDM). This mode assumes a backhaul with little or virtually no delay.

In a second mode (Mode 2), multiple PDCCHs schedule respective PDSCH from multiple TRPs, as shown in FIG. 7B. This mode can be utilized in both non-ideal and ideal backhauls. To support multiple PDCCH monitoring, up to 5 Control Resource Sets (CORESETs) can be configured with up to 3 CORESETs per TRP. As used herein, the term CORESET generally refers to a set of physical resources (e.g., a specific area on the NR Downlink Resource Grid) and a set of parameters that is used to carry PDCCH/DCI. For example, a CORESET may by similar in area to an LTE PDCCH area (e.g., the first 1, 2, 3, 4 OFDM symbols in a subframe).

In some cases, TRP differentiation at the UE side may be based on CORESET groups. CORESET groups may be defined by higher layer signaling of an index per CORESET which can be used to group the CORESETs. For example, for 2 CORESET groups, two indexes may be used (i.e. index=0 and index=1). Thus, a UE may monitor for transmissions in different CORESET groups and infer that transmissions sent in different CORESET groups come from different TRPs. Otherwise, the notion of different TRPs may be transparent to the UE.

### Multiple TCI State Activation for PDCCH and PDSCH

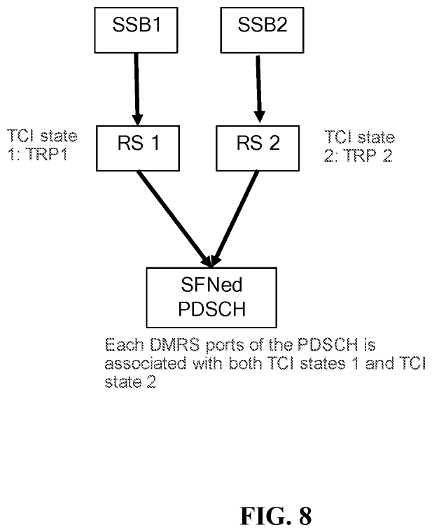

In some cases, it may be desirable to activate more than one TCI state for a PDSCH or PDCCH transmission. For example, in a high speed train (HST) scenario illustrated in FIG. 8, multiple TRPs located along a track may serve a UE at any given time. In some cases, the TRPs may form part of a Single Frequency Network, in which the TRPs use the same frequency to transmit the same information. SFNs are used to extend a coverage area without the use of additional frequencies.

In such scenarios, a TRS may be transmitted separately from each TRP. An SSB may also be transmitted separately from each TRP. Multiple TCI states may be indicated to UE, each of them corresponds to the TRS of one TRP, for example, TCI state 1 for RS 1 from TRP 1 and TCI state 2 for the RS 2 from TRP 2. This may allow the Doppler profile of each TRP may be estimated independently.

As illustrated in FIG. 8, the SFN TRPs (TRP1 and TRP2) may transmit an SFNed PDSCH, according to its own TCI state (TCI state 1 for TRP1 and TCI state 2 for TRP 2). As illustrated, each DMRS port of the PDSCH is associated with both TCI state 1 and TCI state 2. One DMRS port may be QCLed to multiple TRS, such that a single-port DMRS is used while PDSCH is SFNed.

One or two TCI states activation for PDSCH transmission may be supported in various scenarios, such as the single PDCCH mTRP scenario shown in FIG. 7A. In this case, if a single DCI is used to schedule a multi-TCI transmission, the TCI field in the DCI should indicate 2 TCI states for the purpose of receiving the scheduled PDSCH. To accomplish this, a code point of the TCI field in the DCI can point to two QCL relationships. Each TCI code point in the DCI can correspond to 1 or 2 TCI states.

In the HST-SFN scenario shown in FIG. 8, in addition to TCI state activation for PDSCH, one or more TCI states for PDCCH transmissions can also be activated. For scenarios such as HST-SFN, multiple TCI states activation for PDSCH transmission may also be enhanced (e.g., to support activation of more than 2 TCI states).

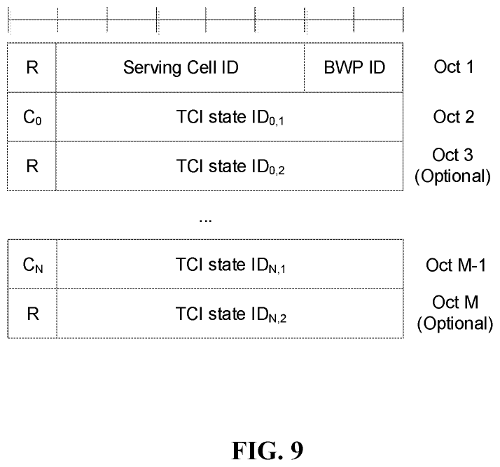

FIG. 9 illustrates one example of a UE-specific MAC CE for activation/deactivation of multiple TCI States for a PDSCH transmission. The MAC CE 900 may be used, for example, for a single PDCCH mTRP scenario (shown in FIG. 7A). As illustrated, there may be a first TCI state ID_{i,1} for each of N code points. In addition, for each code point i, a field Cᵢ may indicate whether a corresponding octet containing a second TCI state ID_{i,2} is present. TCI state ID_{i,j} indicates the TCI state identified by TCI-StateId, where i is the index of the codepoint of the DCI field and j denotes the j^{th} TCI state indicated for the i^{th} codepoint in the DCI in the MAC CE (j=1 or 2).

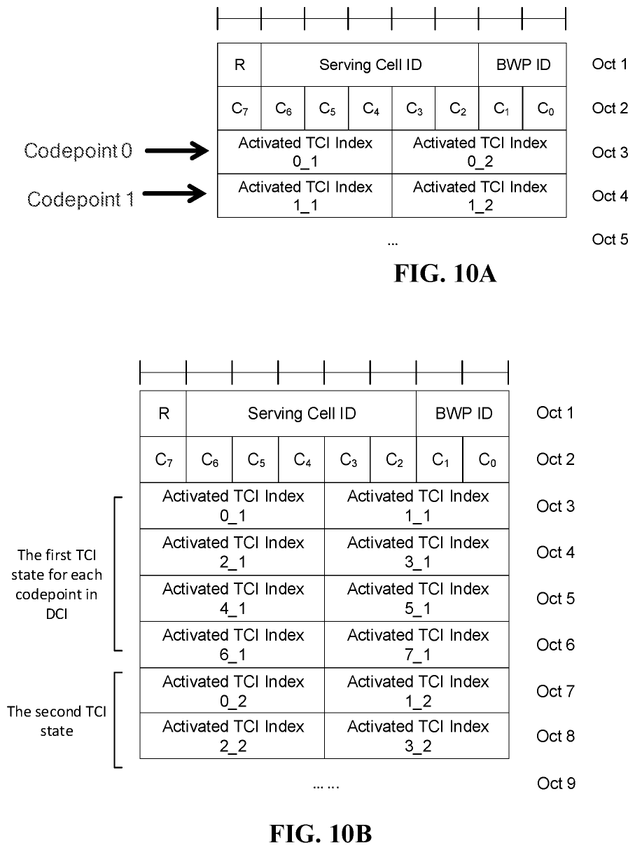

FIG. 10A and FIG. 10B illustrate alternatives of multiple TCI states activation for PDSCH (e.g., for Rel-16 shortened PDCCH mTRP transmissions). As illustrated in FIG. 10A, a first MAC CE may be used to activate up to X TCI states among the configured TCI-StateId. FIG. 10B illustrates a second MAC CE that may be designed to work together with the MAC CE of FIG. 10A to indicate a TCI-state bundle for each TCI codepoint in the DCI (TCI field).

The activated TCI index' fields indicates the index of the activated TCI states, for example, when considering the ordinal position of the activated TCI states in the first MAC CE. As noted above, the Cᵢ field indicates whether the second TCI state (index) is present or not (e.g., all Cᵢ would be set to 1, if two TCI states are indicated for each codepoint).

Aspects of the present disclosure provide techniques that may be considered enhancements for activating multiple transmission configuration indicator (TCI) states. For example, the techniques presented herein may support activating more than two TCI states for PDSCH transmissions and activating one or more TCI states for PDCCH transmissions.

FIGS. 11 and 12 illustrate example operations that may be performed by a UE and network entity, respectively, for activation of multiple TCI states for PDSCH transmissions, in accordance with aspects of the present disclosure.

FIG. 11 illustrates example operations 1100 for wireless communications by a UE, in accordance with certain aspects of the present disclosure. For example, operations 1100 may be performed by a UE 120 of FIG. 1 to determine QCL assumptions for a PDSCH transmission sent from multiple TRPs in an SFN scenario (e.g., the SFNed PDSCH shown in FIG. 8).

Operations 1100 begin, at 1102, by receiving signaling indicating candidate transmission configuration indicator (TCI) states. At 1104, the UE receives a downlink control information (DCI) scheduling a physical downlink shared channel (PDSCH) with a TCI code point that indicates more than 2 TCI states for receiving the PDSCH. For example, the UE may receive a medium access control (MAC) control element (CE) that supports indicating more than two TCI states per TCI code point and a TCI field in the DCI may indicate one of the TCI code points.

At 1106, the UE processes the scheduled PDSCH in accordance with the TCI states indicated by the TCI code point. For example, the UE may process DMRS in the PDSCH with QCL assumptions associated with the indicated TCL states.

FIG. 12 illustrates example operations 1200 for wireless communications by a network entity and may be considered complementary to operations 1100 of FIG. 11. For example, operations 1200 may be performed by a gNB to signal multiple TCI states for an SFNed PDSCH transmission (from multiple TRPs) to a UE 120 performing operations 1100 of FIG. 11.

Operations 1200 begin, at 1202, by transmitting signaling to a user equipment (UE) indicating candidate transmission configuration indicator (TCI) states. At 1204, the network entity transmits a downlink control information (DCI) scheduling a physical downlink shared channel (PDSCH) with a TCI code point that indicates more than 2 TCI states for receiving the PDSCH. At 1206, the network entity transmits the scheduled PDSCH in accordance with the TCI states indicated by the TCI code point.

As noted above, multiple TCI states may be activated via a MAC CE that supports indicating more than two TCI states per TCI code point in a DCI (e.g., for gNB TCI configurations in an HST scenario).

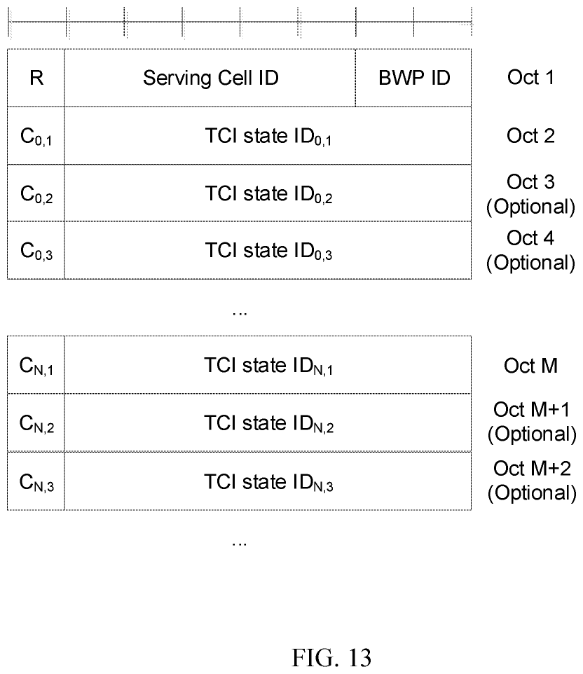

FIG. 13 illustrates one example MAC CE that may be used to activate multiple TCI states for PDSCH (e.g., for mTRP), in accordance with aspects of the present disclosure.

As illustrated, the MAC CE may include, for each TCI code point, a first TCI state ID field indicating a first TCI state ID associated with the TCI code point and multiple optional TCI state ID fields that, if present, indicate multiple other TCI state IDs associated with the TCI code point. In some cases, the network may configure the maximum number of optional TCI state ID fields for the MAC CE.

In the example illustrated in FIG. 13, there are two optional TCI state ID fields. One or multiple TCI states may be activated for each TCI codepoint. A (presence) field C_{i,j} may be used to indicate whether an additional TCI state ID (i.e. ID_{i,j+1}) is present or not. For example, if C_{i,j} is set to 1, the TCI state ID_{i,j+1} is present for codepoint i. On the other hand, if C_{i,j} is set to 0, the next octet is the first TCI state ID of the next codepoint (codepoint i+1).

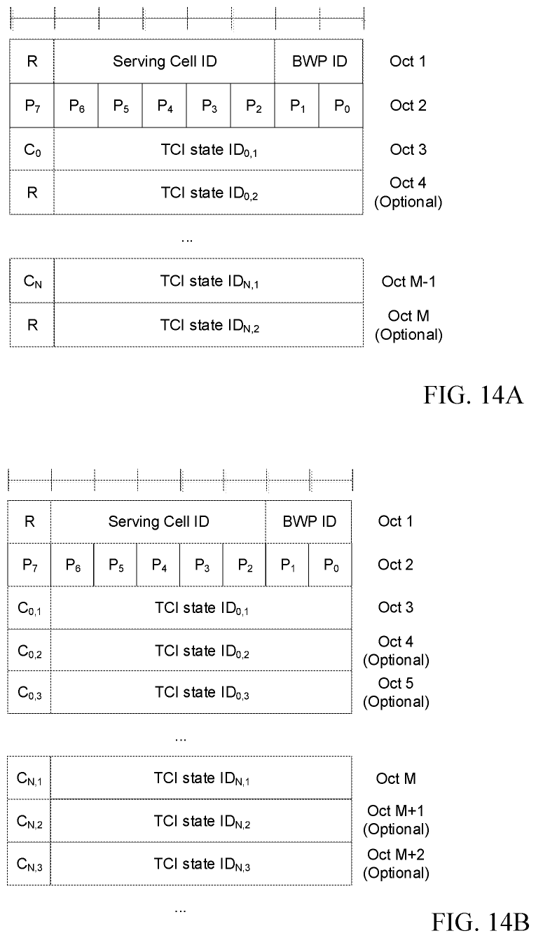

FIGS. 14A and 14B illustrate other examples of a MAC CE structure that may be used to activate multiple TCI states for PDSCH, in accordance with aspects of the present disclosure.

As illustrated, if only a subset of TCI codepoints will be used to indicate the activated TCI states, a bitmap of TCI codepoints (e.g., with 8 bits P₀-P₇, assuming a 3-bit TCI field) is introduced in the second octet. Only the indicated TCI codepoints (with a corresponding bit Pi set to 1) would be associate with the following activated TCI states, indicated in subsequent octets. For those TCI codepoints with (Pi with 0), the associated one or multiple TCI states will not be activated (e.g., which may be considered equivalent to deactivation behavior).

In the example shown in FIG. 14A, each codepoint (with a corresponding bit Pᵢ set to 1) may have a (presence) field Cᵢ to indicate whether an additional TCI state ID (i.e. ID_{i,2}) is present or not. In the example shown in FIG. 14B, each codepoint (with a corresponding bit Pi set to 1) may have a (presence) field C_{i,j} to indicate whether an additional TCI state ID (i.e. IDi,2) is present or not. For example, if C_{0,1} is set to 1, the TCI state ID_{0,2} is present for codepoint 0, if C_{0,2} is set to 1, the TCI state ID_{0,3} is present for codepoint 0, while if C_{0,3} is set to 0, the next octet is the first TCI state ID of the next codepoint (codepoint 1).

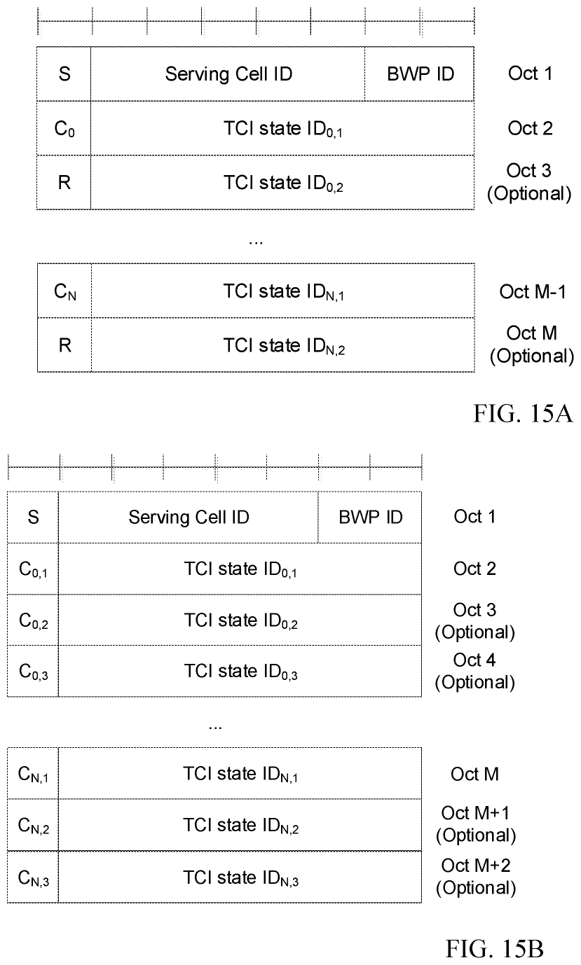

FIGS. 15A and 15B illustrate examples of another MAC CE structure that may be used to activate multiple TCI states for PDSCH, in accordance with aspects of the present disclosure.

As illustrated in FIG. 15A, when compared to the example structure shown in FIG. 9, a bit S (e.g., a previously reserved bit) may be used to differentiate this MAC CE used in the SFN case and non-SFN case (Rel-16 mTRP). The two different scenarios (indicated by the different values of the bit S) may lead to different DMRS configurations and channel estimation, even though they both configure multiple TCI. Thus reuse of a previously reserved (R bit) as an S field to indicate the MAC CE used either for SFN or non-SFN case may assist the UE in better PDSCH processing.

Use of such a bit may be used in any of the options described above. For example, as shown in FIG. 15B, the reserve bit R of the MAC CE shown in FIG. 13 may be used as an S bit to indicate the MAC CE used either for SFN or non-SFN case.

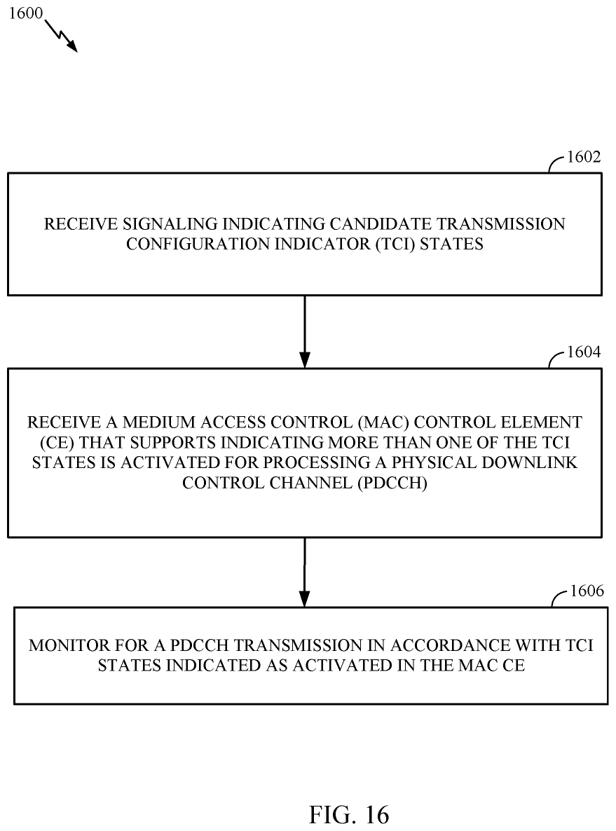

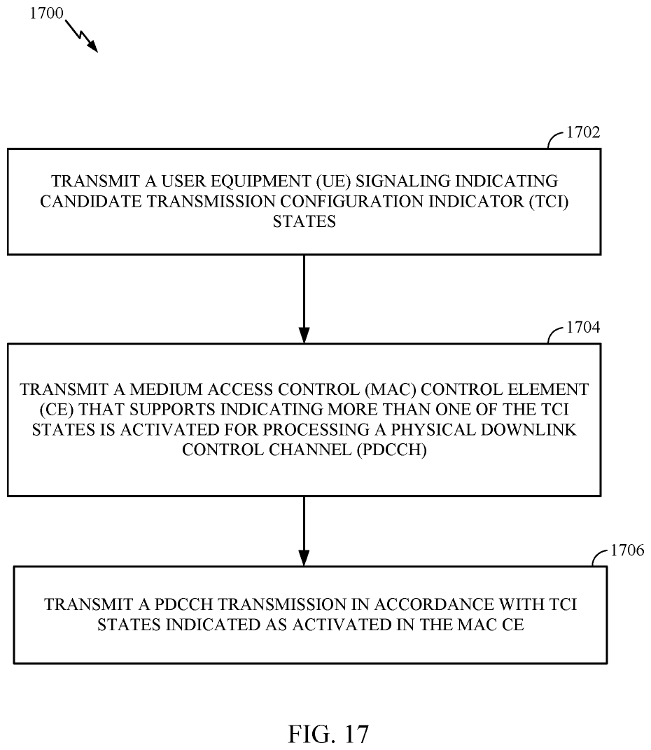

FIGS. 16 and 17 illustrate example operations that may be performed by a UE and network entity, respectively, for activation of multiple TCI states for PDCCH transmissions, in accordance with aspects of the present disclosure.

FIG. 16 illustrates example operations 1600 for wireless communications by a UE, in accordance with certain aspects of the present disclosure. For example, operations 1600 may be performed by a UE 120 of FIG. 1 to determine QCL assumptions for a PDCCH transmission sent from multiple TRPs in an SFN scenario.

Operations 1600 begin, at 1602, by receiving signaling indicating candidate transmission configuration indicator (TCI) states. At 1604, the UE receives a medium access control (MAC) control element (CE) that supports indicating more than one of the TCI states is activated for processing a physical downlink control channel (PDCCH). For example, the UE may receive a MAC CE that supports indicating at least two TCI states for PDCCH transmissions.

At 1606, the UE monitors for a PDCCH transmission in accordance with TCI states indicated as activated in the MAC CE.

FIG. 17 illustrates example operations 1700 for wireless communications by a network entity and may be considered complementary to operations 1600 of FIG. 16. For example, operations 1700 may be performed by a gNB to signal multiple TCI states for an SFNed PDCCH transmission (from multiple TRPs) to a UE 120 performing operations 1600 of FIG. 16.

Operations 1700 begin, at 1702, by transmitting a user equipment (UE) signaling indicating candidate transmission configuration indicator (TCI) states. At 1704, the network entity transmits a medium access control (MAC) control element (CE) that supports indicating more than one of the TCI states is activated for processing a physical downlink control channel (PDCCH). At 1706, the network entity transmits a PDCCH transmission in accordance with TCI states indicated as activated in the MAC CE.

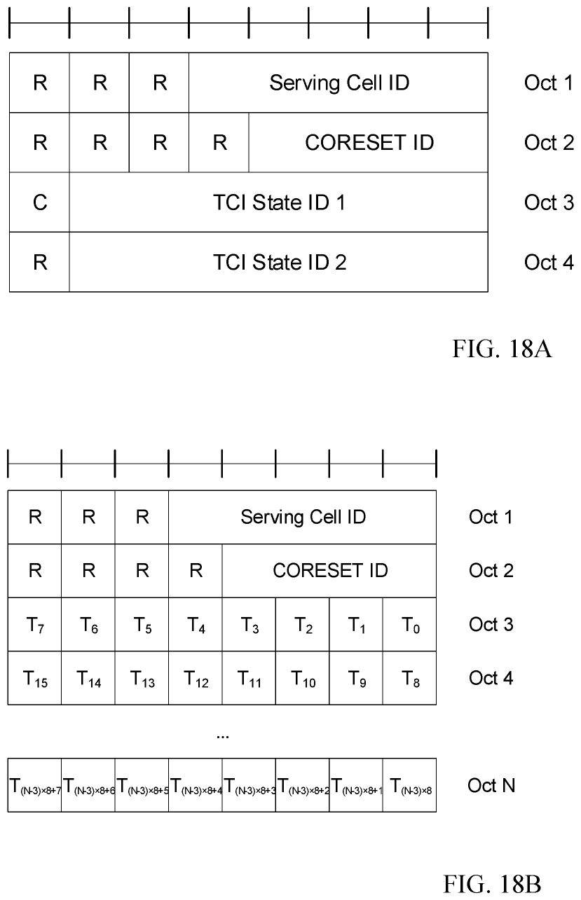

FIGS. 18A and 18B illustrate example MAC CEs that may be used to activate multiple TCI states for PDCCH (e.g., for mTRP), in accordance with aspects of the present disclosure.

As illustrated in the example of FIG. 18A, one or two TCI states may be activated among the configured TCI states for PDCCH. In this example, the C bit indicates whether the second TCI state ID is present of not.

As illustrated in the example of FIG. 18B, multiple TCI states can be activated by using bitmap based solution. In the illustrated example, N octets are used to convey bits, where each bit may be used to indicate if a corresponding one of the (up to (N−3)×8−7) TCI states is activated for PDCCH.

In some cases, the network may configure a list of TCI state patterns, which may provide even greater flexibility for TCI state activation and deactivation for PDSCH and/or PDCCH. For example, RRC signaling may be used to preconfigure TCI state patterns for a set of gNBs in the HST scenario. Each TCI states pattern may indicate multiple selected TCI states combinations for a series of gNBs (e.g., considering a fixed track between to rain and a set of gNBs).

For example, first and second TCI state patterns may be preconfigured as:
TCI states pattern 1 {TCI state ID 1, TCI state ID 2};
TCI states pattern 2 {TCI state ID X, TCI state ID Y}.
   In this case, one TCI states pattern may be considered as TCI trigger states, where a MAC CE activates one or more TCI trigger states, allowing the UE to use the appropriate TCI states. For example, UEs in the different trains may select the appropriate TCI state pattern from the activated TCI trigger states in MAC CE (e.g., based on what gNBs they detect). In some cases (for PDSCH or PDCCH), a MAC CE may activate one or more TCI state patterns. For PDSCH, a TCI code point (in a DCI) may select one of the TCI state patterns.

As described herein, aspects of the present disclosure provides signaling mechanisms for enhanced TCI state activation for PDSCH and/or PDCCH transmissions. The techniques may be suitable in a number of scenarios, such as the HST-SFN scenario shown in FIG. 8.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, processors controller/processor 280 of the UE 120 120 may be configured to perform operations 1100 of FIG. 11 and/or operations 1600 of FIG. 16, while controller/processor 240 of the BS 110 shown in FIG. 2 may be configured to perform operations 1200 of FIG. 12 or operations 1700 of FIG. 17.

Means for receiving may include a receiver (such as one or more antennas or receive processors) illustrated in FIG. 2. Means for transmitting may include a transmitter (such as one or more antennas or transmit processors) illustrated in FIG. 2. Means for determining, means for processing, means for treating, and means for applying may include a processing system, which may include one or more processors of the UE 120 and/or one or more processors of the BS 110 shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 11-12.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
receiving signaling indicating candidate transmission configuration indicator (TCI) states;
receiving a downlink control information (DCI) scheduling a physical downlink shared channel (PDSCH) with a TCI code point that indicates more than 2 TCI states for receiving the PDSCH; and
processing the scheduled PDSCH in accordance with the TCI states indicated by the TCI code point.

2. The method of claim 1, further comprising receiving a medium access control (MAC) control element (CE) that supports indicating more than two TCI states per TCI code point.

3. The method of claim 2, wherein the MAC CE includes, for each TCI code point:
a first TCI state ID field indicating a first TCI state ID associated with the TCI code point; and
optional at least second and third TCI state ID fields that, if present, indicate at least second and third TCI state IDs associated with the TCI code point.

4. The method of claim 3, further comprising receiving signaling indicating a maximum number of optional TCI state ID fields for the MAC CE.

5. The method of claim 3, wherein the MAC CE includes:
a first presence field that indicates whether the optional second TCI state ID field is present in the MAC CE; and
if the optional second TCI state ID field is present, a second presence field that indicates whether the optional third TCI state ID field is present.

6. The method of claim 5, further comprising determining, based on value of one of the first or second presence fields for a first TCI code point, that a next TCI state ID field in the MAC CE is for a next TCI code point.

7. The method of claim 2, wherein the MAC CE includes, a bitmap indicating which TCI code points are associated with TCI states activated or deactivated via the MAC CE.

8. The method of claim 7, wherein the MAC CE includes, for each TCI code point indicated in the bitmap:
a first TCI state ID field indicating a first TCI state ID associated with the indicated TCI code point; and
optional second and third TCI state ID fields that, if present, indicate at least second and third TCI state IDs associated with the indicated TCI code point.

9. The method of claim 8, wherein the MAC CE includes:
a first presence field that indicates whether the optional second TCI state ID field is present in the MAC CE; and
if the optional second TCI state ID field is present, a second presence field that indicates whether the optional third TCI state ID field is present.

10. The method of claim 9, further comprising determining, based on value of one of the first or second presence fields for a first TCI code point, that a next TCI state ID field in the MAC CE is for a next TCI code point indicated in the bitmap.

11. The method of claim 2, wherein:
the MAC CE includes at least one bit that the MAC CE is used for a single frequency network (SFN); and
the UE processes demodulation reference signals (DMRS) of the scheduled PDSCH differently if the at least one bit indicates the MAC CE is used for SFN than if the MAC CE is used for non-SFN.

12. The method of claim 1, wherein the signaling indicating candidate transmission configuration indicator (TCI) states comprises radio resource control (RRC) signaling that configures a set of TCI state patterns for a set of network entities.

13. (canceled)

14. (canceled)

15. (canceled)

16. (canceled)

17. A method for wireless communications by a network entity, comprising:
transmitting signaling to a user equipment (UE) indicating candidate transmission configuration indicator (TCI) states;
transmitting a downlink control information (DCI) scheduling a physical downlink shared channel (PDSCH) with a TCI code point that indicates more than 2 TCI states for receiving the PDSCH; and
transmitting the scheduled PDSCH in accordance with the TCI states indicated by the TCI code point.

18. The method of claim 17, further comprising transmitting a medium access control (MAC) control element (CE) that supports indicating more than two TCI states per TCI code point.

19. The method of claim 18, wherein the MAC CE includes, for each TCI code point:
a first TCI state ID field indicating a first TCI state ID associated with the TCI code point; and
optional at least second and third TCI state ID fields that, if present, indicate at least second and third TCI state IDs associated with the TCI code point.

20. The method of claim 19, further comprising transmitting signaling indicating a maximum number of optional TCI state ID fields for the MAC CE.

21. The method of claim 19, wherein the MAC CE includes:
a first presence field that indicates whether the optional second TCI state ID field is present in the MAC CE; and
if the optional second TCI state ID field is present, a second presence field that indicates whether the optional third TCI state ID field is present.

22. The method of claim 21, further comprising indicating, based on value of one of the first or second presence fields for a first TCI code point, that a next TCI state ID field in the MAC CE is for a next TCI code point.

23. The method of claim 18, wherein the MAC CE includes, a bitmap indicating which TCI code points are associated with TCI states activated or deactivated via the MAC CE.

24. The method of claim 23, wherein the MAC CE includes, for each TCI code point indicated in the bitmap:
a first TCI state ID field indicating a first TCI state ID associated with the indicated TCI code point; and
optional second and third TCI state ID fields that, if present, indicate at least second and third TCI state IDs associated with the indicated TCI code point.

25. The method of claim 24, wherein the MAC CE includes:
a first presence field that indicates whether the optional second TCI state ID field is present in the MAC CE; and
if the optional second TCI state ID field is present, a second presence field that indicates whether the optional third TCI state ID field is present.

26. The method of claim 25, further comprising indicating, based on value of one of the first or second presence fields for a first TCI code point, that a next TCI state ID field in the MAC CE is for a next TCI code point indicated in the bitmap.

27. The method of claim 18, wherein:
the MAC CE includes at least one bit that the MAC CE is used for a single frequency network (SFN); and
the UE processes demodulation reference signals (DMRS) of the scheduled PDSCH differently if the at least one bit indicates the MAC CE is used for SFN than if the MAC CE is used for non-SFN.

28. The method of claim 17, wherein the signaling indicating candidate transmission configuration indicator (TCI) states comprises radio resource control (RRC) signaling that configures a set of TCI state patterns for a set of network entities.

29. (canceled)

30. (canceled)

31. (canceled)

32. (canceled)

33. A method for wireless communications by a user equipment (UE), comprising:
receiving signaling indicating candidate transmission configuration indicator (TCI) states;
receiving a medium access control (MAC) control element (CE) that supports indicating more than one of the TCI states is activated for processing a physical downlink control channel (PDCCH); and
monitoring for a PDCCH transmission in accordance with TCI states indicated as activated in the MAC CE.

34. The method of claim 33, wherein the MAC CE includes:
a first TCI state ID field indicating a first TCI state ID activated for the PDCCH; and
at least an optional second TCI state ID field that, if present, indicate at least a second TCI state ID activated for the PDCCH.

35. The method of claim 34, wherein the MAC CE includes:
a first presence field that indicates whether the optional second TCI state ID field is present in the MAC CE.

36. The method of claim 33, wherein the MAC CE includes a bitmap that indicates one or more of the TCI states that are activated among the candidate TCI states in the list.

37. The method of claim 33, wherein the signaling indicating candidate transmission configuration indicator (TCI) states comprises radio resource control (RRC) signaling that configures a set of TCI state patterns for a set of network entities.

38. (canceled)

39. (canceled)

40. (canceled)

41. A method for wireless communications by a network entity, comprising:
transmitting a user equipment (UE) signaling indicating candidate transmission configuration indicator (TCI) states;
transmitting a medium access control (MAC) control element (CE) that supports indicating more than one of the TCI states is activated for processing a physical downlink control channel (PDCCH); and
transmitting a PDCCH transmission in accordance with TCI states indicated as activated in the MAC CE.

42. The method of claim 41, wherein the MAC CE includes:
a first TCI state ID field indicating a first TCI state ID activated for the PDCCH; and
at least an optional second TCI state ID field that, if present, indicate at least a second TCI state ID activated for the PDCCH.

43. The method of claim 42, wherein the MAC CE includes:
a first presence field that indicates whether the optional second TCI state ID field is present in the MAC CE.

44. The method of claim 41, wherein the MAC CE includes a bitmap that indicates one or more of the TCI states that are activated among the candidate TCI states in the list.

45. The method of claim 41, wherein the signaling indicating candidate transmission configuration indicator (TCI) states comprises radio resource control (RRC) signaling that configures a set of TCI state patterns for a set of network entities.

46. (canceled)

47. (canceled)

48. (canceled)

49. (canceled)

50. (canceled)

51. (canceled)

52. (canceled)

53. An apparatus for wireless communications by a user equipment (UE), comprising:
a receiver configured to receive signaling indicating candidate transmission configuration indicator (TCI) states and to receive a downlink control information (DCI) scheduling a physical downlink shared channel (PDSCH) with a TCI code point that indicates more than 2 TCI states for receiving the PDSCH; and
at least one processor configured to process the scheduled PDSCH in accordance with the TCI states indicated by the TCI code point.

54. (canceled)

55. (canceled)

56. (canceled)
